(19) United States
(12) Patent Application Publication
(10) Pub. No.: US 2014/0209773 A1
(43) Pub. Date: Jul. 31, 2014

(54) TANK HOLDER

(71) Applicant: Brian Lawrence Dorr, Johns Creek, GA (US)

(72) Inventor: Brian Lawrence Dorr, Johns Creek, GA (US)

(21) Appl. No.: 14/164,145

(22) Filed: Jan. 25, 2014

Related U.S. Application Data
(60) Provisional application No. 61/757,213, filed on Jan. 27, 2013.

(51) Int. Cl. F16M 13/00

(52) U.S. Cl. CPC F16M 13/00
USPC 248/346.06

(57) ABSTRACT

An apparatus includes a base member having a substantially planar surface, the base member having cuts that partially define features including a first leg member the first leg member hingably linked to the base member such that the first leg member extends from a planar surface of the base member, a first retaining member the first retaining member operative to engage and substantially retain the first leg member in a substantially upright position, a second leg member the second leg member hingably linked to the base member such that the second leg member extends from the planar surface of the base member, and a second retaining member the second retaining member operative to engage and substantially retain the second leg member in a substantially upright position.

### BACKGROUND

The present invention relates to tank holders. Tanks such as, propane tanks and water tanks are often transported in a vehicle. The tanks are heavy, and are prone to undesirably tip when subjected to forces.

### SUMMARY

An apparatus includes a base member having a substantially planar surface, a first leg member partially defined by a first cut in the base member, the first leg member hingably linked to the base member such that the first leg member extends from a planar surface of the base member, a first retaining member partially defined by a second cut in the base member, the first retaining member operative to engage and substantially retain the first leg member in a substantially upright position, a second leg member partially defined by a third cut in the base member, the second leg member hingably linked to the base member such that the second leg member extends from the planar surface of the base member, and a second retaining member partially defined by a fourth cut in the base member, the second retaining member operative to engage and substantially retain the second leg member in a substantially upright position.

An apparatus includes a base member having a substantially planar surface, the base member having cuts that partially define features including a first leg member the first leg member hingably linked to the base member such that the first leg member extends from a planar surface of the base member, a first retaining member the first retaining member operative to engage and substantially retain the first leg member in a substantially upright position, a second leg member the second leg member hingably linked to the base member such that the second leg member extends from the planar surface of the base member, and a second retaining member the second retaining member operative to engage and substantially retain the second leg member in a substantially upright position.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a perspective view of an exemplary embodiment assembled holding apparatus.

FIG. 2 illustrates another perspective view of an exemplary embodiment of the holding apparatus of FIG. 1.

FIG. 3 illustrates a top view of the holder when folded.

FIG. 4 illustrates an alternate embodiment of the holder when folded.

### DETAILED DESCRIPTION

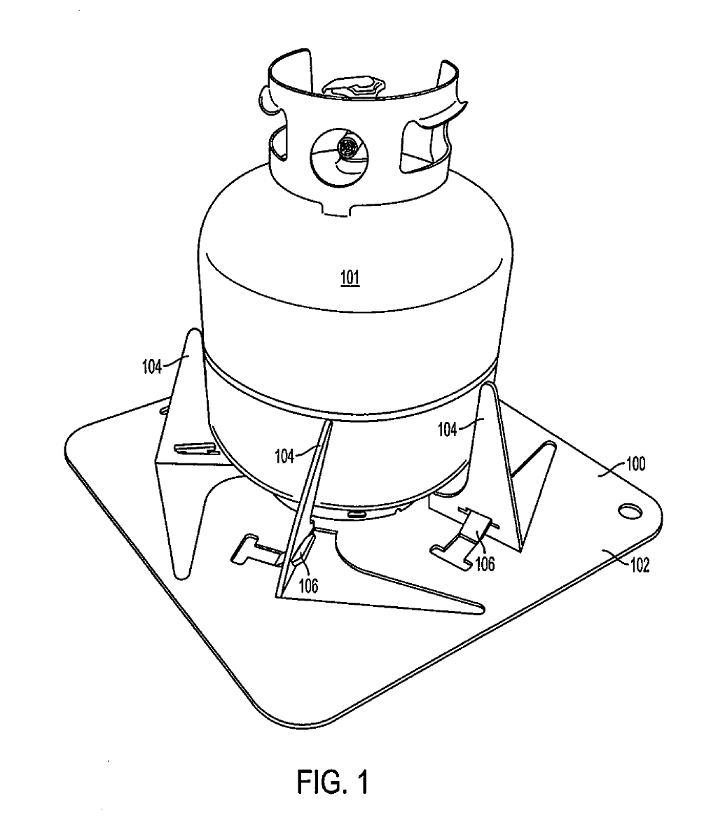

FIG. 1 illustrates a perspective view of an exemplary embodiment assembled holding apparatus (holder) 100 and tank 101. The holder 100 includes a base portion 102, leg portions 104, and a leg retaining portions 106 that are operative to increase the stability of the tank 101 in an upright position. In the illustrated embodiment, the holder 100 is formed from a corrugated sheet product material such as, for example, a cellulose, pulp, fiber, plastic, or polymer material. However, the holder 100 may be formed from any appropriate sheet material.

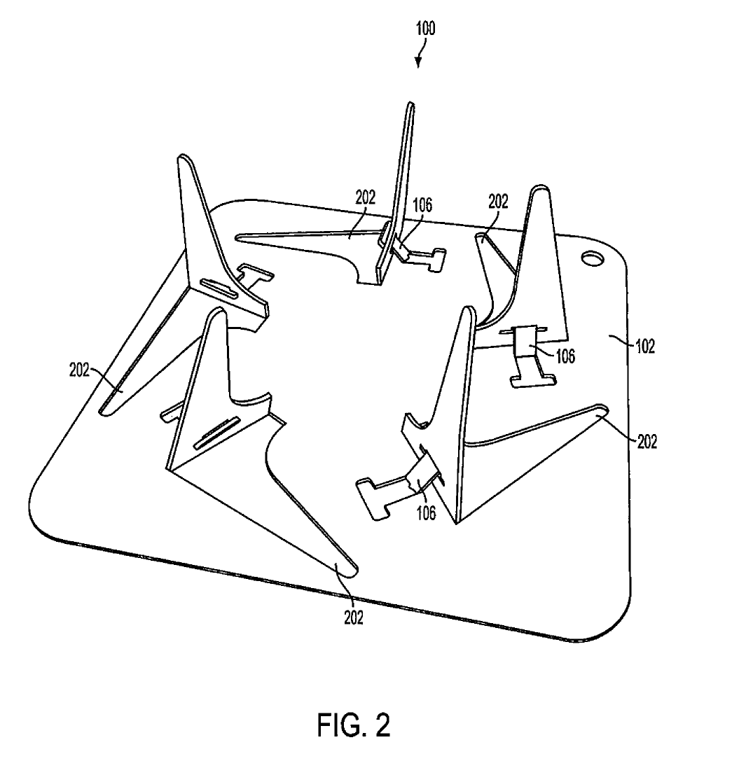

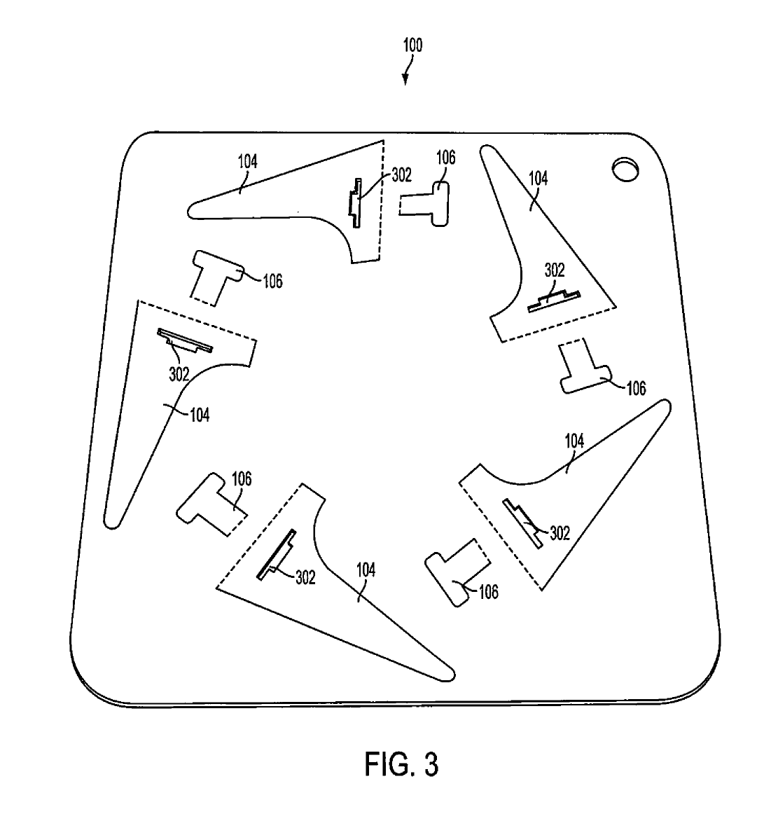

FIG. 2 illustrates another perspective view of an exemplary embodiment of the holder 100. The base portion 102 includes a planar surface that defines cut out regions 202 that define the leg portions 104 that are hingably connected to the planar surface. In operation, a tank 101 (of FIG. 1) or a similarly shaped object is placed on the base portion 102. The leg members 104 hingably (pivotably) fold upwardly from the base portion 102. The leg members 104 are retained in an upright position by the leg retaining portions 106 that are defined by corresponding cut out regions that define the leg retaining portions 106, which hingably (pivotably) fold upwardly from the base portion 102. The leg retaining portions 106 engage slots 302 (see FIG. 3), or cut out portions of the leg portions 104 that are operative to mechanically connect or link the leg retaining portions 106 with the leg portions 104 to provide support, stability, and to retain the leg portions 104 in a substantially upright position. The leg portions include a curved profile edge that is similar to the outer surface profile of a portion of the tank 101. The leg portions 104 are arranged substantially radially from a center of the base portion 102.

FIG. 3 illustrates a top view of the holder 100 in a flat or folded arrangement.

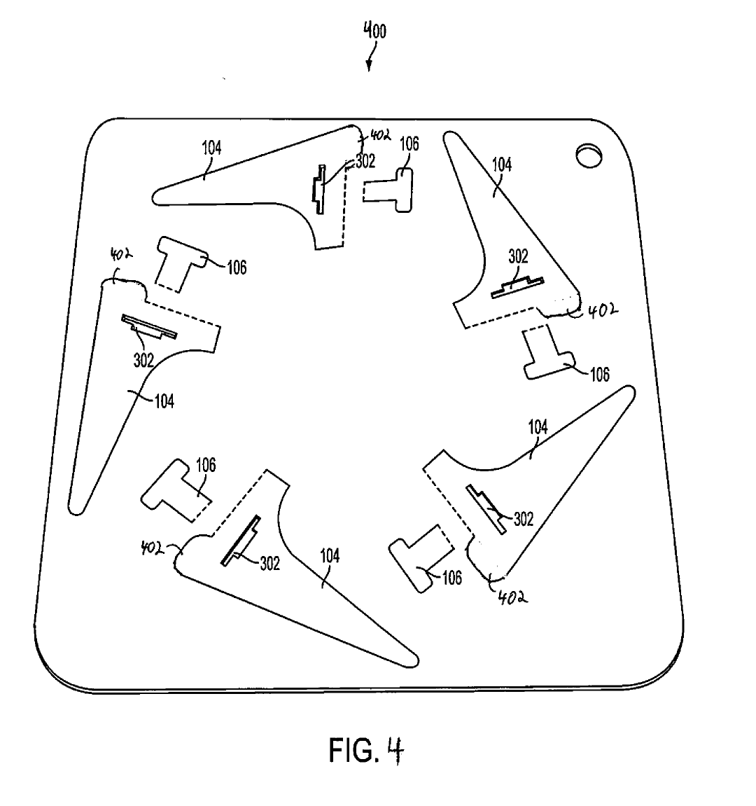

FIG. 4 illustrates a top view of an alternate embodiment of a holder 400. The holder 400 includes tabular extension portions 402 that are partially defined by a cut in the base portion 102. The tabular extension portions 402 are operative to extend outwardly from the bottom surface of the base portion 102 while the leg portions 104 extend outwardly from the top surface of the base portion 102. The tabular extension portions 402 are operative to increase friction and to engage with a resting surface (not shown) when the holder 400 is disposed on a resting surface. The tabular extension portions 402 may deform the resting surface to increase friction and provide a mechanical engagement with the deformed surface. For example, is the resting surface is a deformable surface such as, for example, an upholstered seat or bench, when weighted with the tank 101, the tabular extension portions 402 deform the resting surface and assist in securing the holder 400 on the resting surface.

The embodiments of the holder described above provide an economical holder for tanks. Multiple holders 100 may be stacked for retail or storage. Following use by a user, the holder 100 may be returned to a substantially planar arrangement by folding the extending leg portions 104 and leg retaining portions 106 into their original positions as shown in FIG. 3.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. An apparatus including:
a base member having a substantially planar surface;
a first leg member partially defined by a first cut in the base member, the first leg member hingably linked to the base member such that the first leg member extends from a planar surface of the base member;
a first retaining member partially defined by a second cut in the base member, the first retaining member operative to engage and substantially retain the first leg member in a substantially upright position;
a second leg member partially defined by a third cut in the base member, the second leg member hingably linked to the base member such that the second leg member extends from the planar surface of the base member; and
a second retaining member partially defined by a fourth cut in the base member, the second retaining member operative to engage and substantially retain the second leg member in a substantially upright position.

2. The apparatus of claim 1, wherein the first retaining member is operative to engage a slot arranged in the first leg member.

3. The apparatus of claim 1, wherein the first leg member includes a tabular extension portion that is operative to extend outwardly from the planar surface in a direction opposing the first leg member.

4. The apparatus of claim 1, wherein the first leg member includes a tabular extension portion that extends outwardly from the planar surface from a bottom side of the base member while the first leg ember extends outwardly from the planar surface from a top side of the base member.

5. The apparatus of claim 1, wherein the apparatus is operative to support a tank.

6. The apparatus of claim 1, wherein the first leg member includes an edge having a curved profile corresponding to a profile of an outer surface of a tank.

7. The apparatus of claim 1, wherein the first leg member and the second leg member are arranged radially around a center of the base member.

8. The apparatus of claim 1, further comprising:
a third leg member partially defined by a fifth cut in the base member, the third leg member hingably linked to the base member such that the third leg member extends from the planar surface of the base member; and
a third retaining member partially defined by a sixth cut in the base member, the third retaining member operative to engage and substantially retain the third leg member in a substantially upright position.

9. The apparatus of claim 1, wherein the apparatus includes a sheet material.

10. The apparatus of claim 1, wherein the apparatus includes a corrugated sheet material.

11. An apparatus including:
a base member having a substantially planar surface, the base member having cuts that partially define features including:
a first leg member the first leg member hingably linked to the base member such that the first leg member extends from a planar surface of the base member;
a first retaining member the first retaining member operative to engage and substantially retain the first leg member in a substantially upright position;
a second leg member the second leg member hingably linked to the base member such that the second leg member extends from the planar surface of the base member; and
a second retaining member the second retaining member operative to engage and substantially retain the second leg member in a substantially upright position.

12. The apparatus of claim 11, wherein the first retaining member is operative to engage a slot arranged in the first leg member.

13. The apparatus of claim 11, wherein the first leg member includes a tabular extension portion that is operative to extend outwardly from the planar surface in a direction opposing the first leg member.

14. The apparatus of claim 11, wherein the first leg member includes a tabular extension portion that extends outwardly from the planar surface from a bottom side of the base member while the first leg ember extends outwardly from the planar surface from a top side of the base member.

15. The apparatus of claim 11, wherein the apparatus is operative to support a tank.

16. The apparatus of claim 11, wherein the first leg member includes an edge having a curved profile corresponding to a profile of an outer surface of a tank.

17. The apparatus of claim 11, wherein the first leg member and the second leg member are arranged radially around a center of the base member.

18. The apparatus of claim 11, further comprising:
a third leg member the third leg member hingably linked to the base member such that the third leg member extends from the planar surface of the base member; and
a third retaining member the third retaining member operative to engage and substantially retain the third leg member in a substantially upright position.

19. The apparatus of claim 11, wherein the apparatus includes a sheet material.

20. The apparatus of claim 11, wherein the apparatus includes a corrugated sheet material.
